(19) United States
(12) Patent Application Publication
(10) Pub. No.: US 2017/0080660 A1
(43) Pub. Date: Mar. 23, 2017

(54) FLUID-EXTRACTING PRESS

(71) Applicant: Daniel Mark Lucas, Burnt Ranch, CA (US)

(72) Inventor: Daniel Mark Lucas, Burnt Ranch, CA (US)

(21) Appl. No.: 14/857,286

(22) Filed: Sep. 17, 2015

(51) Int. Cl. B30B 9/10; B30B 15/06

(52) U.S. Cl. CPC B30B 9/10; B30B 15/064

(57) ABSTRACT

An press is described useful for pressuring a plant, such as an herb, or portion of the plant to yield fluids (e.g., oil, juice). The press includes a lower plate and an upper plate connected by a number of posts perpendicular to the plates. Each plate includes two or more bars and channels between the bars. When the plates meet, the bars' upper surfaces can overlap with those from the opposite plate, pressing the plant in between. A rack can be used for loading the plant into the press and rack holders can be placed on the lower plate to guide and receive the rack.

### BACKGROUND

Many plants, especially medically useful herbs, contain valuable components that can be extracted in the form of a fluid (e.g., oil). One example of such oil is essential oil. Essential oil is used in cosmetics, aromatherapy and medicine. Pressurized steam can be used to extract the volatile plant oils. The steam then cools into a liquid that contains both essential oil and the water used to extract it. Plant oils are typically extracted by both crushing and pressing plant material and by the more complex process of steam distillation.

### SUMMARY

The present disclosure provides apparatuses and methods for extracting fluid, such as oil, from plants. In one embodiment, provided is a press comprising a first plate comprising an upper layer and a lower layer, wherein the upper layer comprises two or more substantially rectangular bars, each bar has a substantially flat upper surface distal from the lower layer, and the bars are aligned parallel to each other to form one or more channels therebetween, two or more posts extending from the lower layer and surrounding the bars of the first plate, wherein the posts are perpendicular to the upper surfaces of the bars of the first plate, a second plate comprising an upper layer and a lower layer, wherein the upper layer comprises two or more substantially rectangular bars each having a substantially flat upper surface distal from the lower layer, wherein the lower layer is slidably attached to the posts, and wherein when the second plate slides along the posts towards the first plate, the upper surface of each of the bars of the second plate can substantially match the upper surface of a corresponding bar of the first plate, and two parallel rack holders disposed on the first plate outside of the bars, configured to receive a rack that slides from outside of the press into a space between the first and second plates.

In some aspects, the rack holders are parallel to the bars of the first plate. In some aspects, the rack holders have a concave upper surface distal from the first plate.

In some aspects, the press further comprises a spring around each of the posts, disposed between the first plate and the second plate.

In some aspects, the first plate further comprises a middle layer disposed between the upper layer and the lower layer and between the posts, wherein the channels between the bars of the first plate are formed on the middle layer. In some aspects, the second plate further comprises a middle layers disposed between the upper layer and the lower layer and between the posts. In some aspects, the lower layer of the first plate is about 0.2 to 2 inches thick. In some aspects, the middle layer of the first plate is about 0.2 to 1 inch thick. In some aspects, the bars of the first plate each is about 0.2 to 1 inch thick.

In some aspects, the lower layers of the first plate and the second plate are substantially rectangular. In some aspects, the press comprises four posts disposed as each corner of the lower layers of the first plate and the second plate.

In some aspects, the total width of the channels is about 10%-100% of the total width of the bars. In some aspects, the press further comprises a rack which, when inserted between the first and second plates and placed on the rack holders, allows the bars of the first plate to match the bars of the second plate. In some aspects, the rack comprises two halves comprising magnetic material for holding the two halves together.

In some aspects, the press further comprises a heater inside each of the first plate and the second plate to heat the bars. In some aspects, the press further comprises wires connected to the heaters.

Methods of using the press are also provided, in one embodiment, the disclosure provides a method of extracting fluid from a plant, comprising: (a) placing the plant between two sheets; (b) placing the sheets between two halves of a rack, held together by magnetic forces; (c) inserting the rack into a press that comprises a first plate comprising an upper layer and a lower layer, wherein the upper layer comprises two or more substantially rectangular bars, each bar has a substantially flat upper surface distal from the lower layer, and the bars are aligned parallel to each other to form one or more channels therebetween, two or more posts extending from the lower layer and surrounding the bars of the first plate, wherein the posts are perpendicular to the upper surfaces of the bars of the first plate, a second plate comprising an upper layer and a lower layer, wherein the upper layer comprises two or more substantially rectangular bars each having a substantially flat upper surface distal from the lower layer, wherein the lower layer is slidably attached to the posts, and wherein when the second plate slides along the posts towards the first plate, the upper surface of each of the bars of the second plate can substantially match the upper surface of a corresponding bar of the first plate, and two parallel rack holders disposed on the first plate outside of the bars, configured to receive the rack that slides from outside of the press into a space between the first and second plates, and (d) pushing the upper plate towards the lower plate, thereby pressuring the plant to yield a fluid. In some aspects, the plant is a leaf, a brunch, a root, or a fruit.

### BRIEF DESCRIPTION OF THE DRAWINGS

Provided as embodiments of this disclosure are drawings which illustrate by exemplification only, and not limitation, wherein:

FIG. 1 illustrates a press with a lower plate and a moveable upper plate which, when moved towards the lower plate, can press plants placed in between to yield a fluid;

FIG. 2 illustrates that a rack is placed above the lower plate and supported by two rack holders;

FIG. 3 shows a sheet placed on the rack holder; and

FIG. 4 shows two sheets held between two racks (only the upper rack is visible).

It will be recognized that some or all of the figures are schematic representations for exemplification and, hence, that they do not necessarily depict the actual relative sizes or locations of the elements shown. The figures are presented for the purpose of illustrating one or more embodiments with the explicit understanding that they will not be used to limit the scope or the meaning of the claims that follow below.

### DETAILED DESCRIPTION

The present disclosure provides an apparatus in the form of a press. Such an apparatus provides an efficient and convenient means for extracting fluid from a plant.

### Press

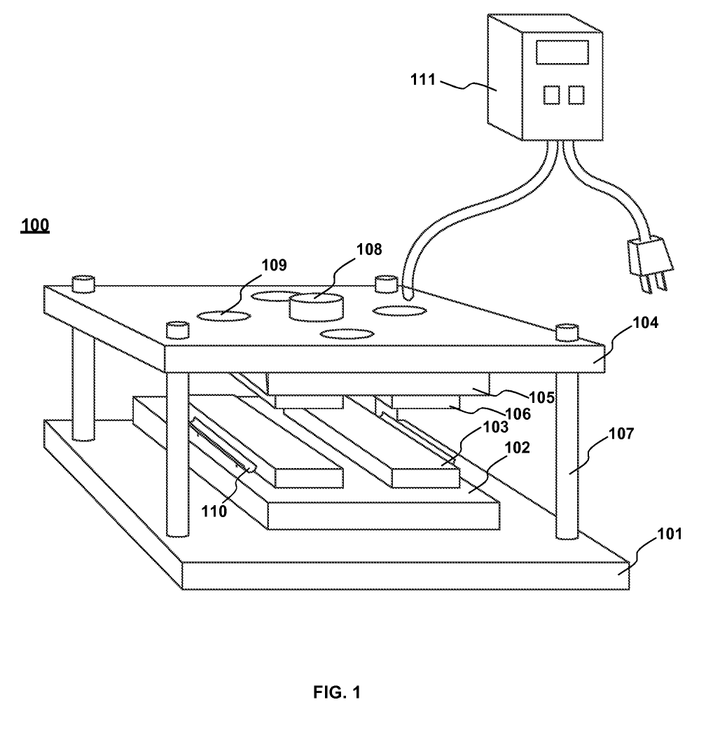

FIG. 1 illustrates one embodiment of the press (100). The press includes a lower plate and an upper plate. The lower plate includes at least two layers, a lower layer (101) that serves as a base for the press, and an upper layer that includes two or more bars (103). Optionally, there is an additional middle layer (102) that connects the lower player and the upper layer of the bars.

The upper plate is similarly structured, including a base layer (104) and two or more bars (106) disposed on (directly or indirectly) the base layer. Optionally, the upper plate includes a middle layer (105) between the base layer and the upper layer.

The upper plate is connected to the lower plate through two or more posts (107). In one aspect, two or three posts are used. In one aspect, four posts are used. In one aspect, more than four posts are used. The posts are preferably placed outside the bars. In other words, viewed from above, the horizontal cross-section of each of the posts (i.e., a circle) is outside a closed area formed by all of the bars, and spaces between them.

At seen later, the outside location of the posts will allow a rack to be inserted between the bars of the upper plate and those of the lower plate. When two posts are used, each is placed on either side of the bars. If four posts are used, they can be placed at four corners as shown in FIG. 1, whether the plates are rectangular or round/oval in shape. In some aspects, there are bushings in each of the holes of the upper plate, through which the posts slide, to facilitate sliding.

In some aspects, the posts (107) are disposed on the lower layer (101, as shown) of the lower plate, extending upwards (perpendicular to the lower plate). In some aspects, the posts are disposed on the middle layer (102, not shown in FIG. 1) in a likewise manner. In some aspects, each post is surrounded with one or more spring disposed between the plates to push the plates away from each other when needed (not shown).

The upper plate is connected to the posts (107) in a similar manner except that the bars of the upper plate will be facing towards the lower plates when connected. In some aspects, the upper plate is connected to each of the posts slideably. Alternatively, the lower plate can be connected to each of the posts slideably. In either case, the posts allow the upper plate and the lower plate to travel to or from each other.

A. Pressing Bars

Each of the upper plate and lower plate includes two or more bars to form a top layer. In one embodiment, each of the bars is substantially rectangular, but other shapes can be used as well. For instance, the bars can be square, oval, hexagonal, or triangular.

In some embodiments, the bars are placed such that the top side of the bar (i.e., the surface distant from the lower layer) is substantially flat and is perpendicular to the posts. Accordingly, when the plates meet (e.g., when the upper plate slides down the posts), the top surface of the bars 103 will get in contact with the lower surface of the bars 106. In this embodiment, it can be appreciated that the configuration of the bars on the lower plate forms preferably a mirror image of that on the upper plate, even though a perfect match is not required.

When the bars of the lower plate are pressed against the bars from the upper plate while a plant or a portion of a plant (e.g., leaf, branch, root, fruit, seed etc) is inserted in between, the bars impose pressure on the plant to squeeze fluid from the plant. The fluid then flows into the space between the bars and then exits the press to be collected. Accordingly, as shown in FIG. 1, the bars on both plates are arranged so that they leave channels between them to allow fluid to flow through.

To facilitate such flow, in one embodiment, the bars are placed in parallel to each other. In one embodiment, each of the lower plate and the upper plate has two parallel bars forming a channel in between. In one embodiment, each plate has three, four, five or more parallel bars forming multiple channels in between. In one embodiment, each plate has two rows of bars, each row including two or more parallel bars. These bars form one or more channels in one direction and a channel that is perpendicular to the other channels.

As provided above, the bars on the lower plate can form a pattern that is substantially a mirror image of the pattern of the bars on the upper plate. Such an arrangement is useful in maximizing the overlapped area of the bars which is the effective area for pressing the plant. In one aspect, the overlapped area between the upper plate and the lower plate is at least about 75%, 80%, 85%, 90%, 95%, 98% or 99% of the area of total area of all the bars on one of the plates.

The size of each components of the press can be tailored to particular needs. In one aspect, each bar is from 0.1 to 2 inches thick. In one aspect, the thickness of the bars is from 0.2 to 1.5 inches, 0.2 to 1 inch, 0.3 to 0.8 inch, 0.4 to 0.6 in, or about 0.4, 0.5, or 0.6 inch. In some aspects, each bar is from 1 to 10 inches wide, or from 2 to 8 inches wide, or from 3 to 7 inches wide, or from 4 to 6 inches wide. In some aspects, each bar is 4 to 50 inches long, or 5 to 40 inches long, or 10 to 30 inches long, or 15 to 20 inches long.

The sizes of the lower layer of the lower plate (or the base layer of the upper layer) and the middle layers can also be tailored. In one aspect, the lower layer (or the base layer) is from 0.1 to 2 inches thick. In one aspect, the lower layer (or the base layer) is from 0.2 to 1.5 inches, 0.2 to 1 inch, 0.3 to 0.8 inch, 0.4 to 0.6 in, or about 0.4, 0.5, or 0.6 inch thick. In one aspect, the lower layer (or the base layer) is from 5 to 100 inches wide, or from 10 to 80 inches, from 10 to 70 inches, from 20 to 60 inches, or from 20 to 50 inches wide. In one aspect, the lower layer (or the base layer) is from 5 to 200 inches long, or from 10 to 150 inches, from 10 to 140 inches, from 20 to 120 inches, form 20 to 100 inches, from 30 to 90 inches, from 30 to 80 inches, from 40 to 60 inches long. In one aspect, the middle layer is from 0.2 to 1.5 inches, 0.2 to 1 inch, 0.3 to 0.8 inch, 0.4 to 0.6 in, or about 0.4, 0.5, or 0.6 inch thick. In one aspect, the middle layer has a horizontal area that is from 60%, 70% or 80% to 80%, 85%, 90% or 95% of the area of the lower layer.

When in use, the bars can be in contact with the plant, or with sheets (e.g., paper) that cover the plant. In one embodiment, therefore, the surface of the bars is smooth, polished, and/or water repellant. In one embodiment, the surface is made of a material that is food-compatible, such as food grade stainless steel (e.g., grade 304).

B. Racks and Rack Holders

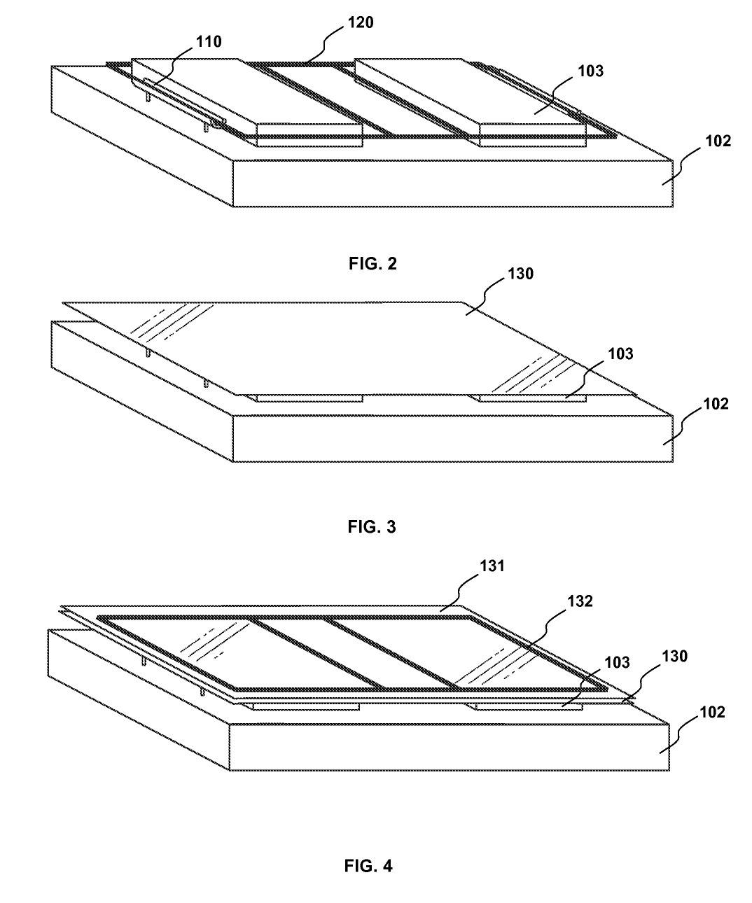

In some embodiments, a rack is designed to load a plant (or a portion of a plant, e.g., leaf, branch, root, and fruit) into the press between the plates. One embodiment of the rack is illustrated in FIG. 2 as 120. In FIG. 2, the rack is shown as a frame with six edges, forming three empty rectangles. When the rack is inserted between the plates (upper plate not shown), two or the rectangles encircle each of the two bars, and the third is placed between the bars within the channel. Nevertheless, a rack can have more edges, can take different shapes or do not have to have six edges. A simpler design, for instance, is rectangular shape with just four edges that encircle both bars.

In another embodiment, the rack has sufficient edges such that when the rack is placed on the plates, each bar (or each pair of bars from both plates) is separated from other bars. In one embodiment, the rack forms a sub-area around each bar and the sub-area is not larger than 150% (or not more than 140%, 130%, 120% or 110%) of the size (i.e., the upper surface area) of the bar.

To guide the loading of the rack into the press, in some embodiments, the press further includes one, two or more rack holders. In one embodiment, at least two rack holders are used, placed on both sides of the bars in parallel. As illustrated in FIG. 2, rack holders 110 each has a concave upper surface to accommodate one edge of the rack. In some aspects, each of the rack holders is at last 1 inch long, and as long as the bars.

It is contemplated that the rack holders can be removeably disposed on the lower plate (either on the middle layer, which is as shown, or the lower layer). Depending on the size or shape of the rack (multiple racks may be provided to a user) being used, the rack holders can be re-positioned. As shown in FIG. 2, each rack holder has two (or more) bars underneath (and the lower plate has corresponding holes) for such positioning.

FIG. 3 illustrates that a sheet (130) can be placed on the rack (not visible). This sheet in the drawing can represent a leaf that will be pressed, or a sheet useful for holding leaves (or other parts of the plant). In one embodiment, two sheets and two racks (or two halves of a rack) can be used, as illustrated in FIG. 4. When two racks (132 and 120, which is not visible) are used, the two sheets are enclosed in between, which in turn can hold plants between them for fluid-extraction. In some aspects, the racks include magnets (e.g., neodymium magnets) so that they can be held together by magnetic force. When the racks are held together by such a force, the sheet in between (as well as the plants between the sheets) can be held tight, allowing effective pressing by the press.

C. Control and Use of the Press

The upper plate can be designed to facilitate application of force. For instance, as illustrated in FIG. 1, a relatively small cylinder (108) and four circular marks are useful for guiding an external press to push the upper plate towards the lower plate. As provided above, to return the upper plate to non-pressing position afterwards, a spring can be installed around each post.

In some embodiments, a heater is used inside the press to heat the bars. Heated bars can be useful for fluid-extraction for certain plants. To control heating and/or the pressing action, a control unit (111) can be used, connecting to press (or installed within the press). The control unit, in some aspect, includes program code and human interface to implement the control.

Method of Extracting Fluid from a Plant

From FIGS. 3 and 4, it is readily understood that when the upper plate is pressed against the lower plate, the plants held between the sheets will be pressed to yield fluid (e.g., oil, juice). Accordingly, in one embodiment, a method for fluid-extraction is provided. The method entails inserting a rack to the press of the present disclosure, between the plates, such that the rack is held by the rack holders. In one aspect, a plant or a portion of the plant is placed on the rack. In one aspect, the plant or portion is placed on a sheet (e.g., paper sheet) which is placed on the rack. In another aspect, the plant or portion is placed between two sheets, and the two sheets are held together by two racks (or two halves of a rack).

When the rack is placed on the rack holders, the plant or the portion of the plant is placed above the bar(s). Therefore, when the upper plate is pushed to meet with the lower plate, the plant is pressured to yield fluids. In some embodiments, the bars are heated to facilitate fluid extraction. The fluid then flows to the channels between the bars and are collected accordingly.

Although the discussions above may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this disclosure belongs.

The disclosures illustratively described herein may suitably be practiced in the absence of any element or elements, limitation or limitations, not specifically disclosed here. For example, the terms “comprising”, “including,” containing,” etc. shall be read expansively and without limitation. Additionally, the terms and expressions employed here have been used as terms of description and not of limitation; hence, the use of such terms and expressions does not evidence and intention to exclude any equivalents of the features shown and described or of portions thereof. Rather, it is recognized that various modifications are possible within the scope of the disclosure claimed.

By the same token, while the present disclosure has been specifically disclosed by preferred embodiments and optional features, the knowledgeable reader will apprehend modification, improvement and variation of the subject matter embodied here. These modifications, improvements and variations are considered within the scope of the disclosure.

The disclosure has been described broadly and generically here. Each of the narrower species and subgeneric groupings falling within the generic disclosure also form part of the disclosure. This includes the generic description of the disclosure with a proviso or negative limitation removing any subject matter from the genus, regardless of whether or not the excised material is described specifically.

Where features or aspects of the disclosure are described by reference to a Markush group, the disclosure also is described thereby in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

Although the disclosure has been described in conjunction with the above-mentioned embodiments, the foregoing description and examples are intended to illustrate and not limit the scope of the disclosure. Other aspects, advantages and modifications within the scope of the disclosure will be apparent to those skilled in the art to which the disclosure pertains.

1. A press comprising:
a first plate comprising an upper layer and a lower layer, wherein the upper layer comprises two or more substantially rectangular bars, each bar has a substantially flat upper surface distal from the lower layer, and the bars are aligned parallel to each other to form one or more channels therebetween,
two or more posts extending from the lower layer and surrounding the bars of the first plate, wherein the posts are perpendicular to the upper surfaces of the bars of the first plate,
a second plate comprising an upper layer and a lower layer, wherein the upper layer comprises two or more substantially rectangular bars each having a substantially flat upper surface distal from the lower layer, wherein the lower layer is slidably attached to the posts, and wherein when the second plate slides along the posts towards the first plate, the upper surface of each of the bars of the second plate can substantially match the upper surface of a corresponding bar of the first plate, and
two parallel rack holders disposed on the first plate outside of the bars, configured to receive a rack that slides from outside of the press into a space between the first and second plates.

2. The press of claim 1, wherein the rack holders are parallel to the bars of the first plate.

3. The press of claim 1, wherein the rack holders have a concave upper surface distal from the first plate.

4. The press of claim 1, further comprising a spring around each of the posts, disposed between the first plate and the second plate.

5. The press of claim 1, wherein the first plate further comprises a middle layer disposed between the upper layer and the lower layer and between the posts, wherein the channels between the bars of the first plate are formed on the middle layer.

6. The press of claim 5, wherein the second plate further comprises a middle layers disposed between the upper layer and the lower layer and between the posts.

7. The press of claim 5, wherein the lower layer of the first plate is about 0.2 to 2 inches thick.

8. The press of claim 7, wherein the middle layer of the first plate is about 0.2 to 1 inch thick.

9. The press of claim 7, wherein the bars of the first plate each is about 0.2 to 1 inch thick.

10. The press of claim 1, wherein the lower layers of the first plate and the second plate are substantially rectangular.

11. The press of claim 10, comprising four posts disposed as each corner of the lower layers of the first plate and the second plate.

12. The press of claim 1, wherein the total width of the channels is about 10%-100% of the total width of the bars.

13. The press of claim 1, further comprising a rack which, when inserted between the first and second plates and placed on the rack holders, allows the bars of the first plate to match the bars of the second plate.

14. The press of claim 13, wherein the rack comprises two halves comprising magnetic material for holding the two halves together.

15. The press of claim 1, further comprising a heater inside each of the first plate and the second plate to heat the bars.

16. The press of claim 15, further comprising wires connected to the heaters.

17. A method of extracting fluid from a plant, comprising:
(a) placing the plant between two sheets;
(b) placing the sheets between two halves of a rack, held together by magnetic forces;
(c) inserting the rack into a press that comprises a first plate comprising an upper layer and a lower layer, wherein the upper layer comprises two or more substantially rectangular bars, each bar has a substantially flat upper surface distal from the lower layer, and the bars are aligned parallel to each other to form one or more channels therebetween,
two or more posts extending from the lower layer and surrounding the bars of the first plate, wherein the posts are perpendicular to the upper surfaces of the bars of the first plate,
a second plate comprising an upper layer and a lower layer, wherein the upper layer comprises two or more substantially rectangular bars each having a substantially flat upper surface distal from the lower layer, wherein the lower layer is slidably attached to the posts, and wherein when the second plate slides along the posts towards the first plate, the upper surface of each of the bars of the second plate can substantially match the upper surface of a corresponding bar of the first plate, and
two parallel rack holders disposed on the first plate outside of the bars, configured to receive the rack that slides from outside of the press into a space between the first and second plates, and
(d) pushing the upper plate towards the lower plate, thereby pressuring the plant to yield a fluid.

18. The method of claim 17, wherein the plant is a leaf, a brunch, a root, or a fruit.
